(19) United States
(12) Patent Application Publication
(10) Pub. No.: US 2026/0058755 A1
(43) Pub. Date: Feb. 26, 2026

(54) SOFT-BIASED SUCCESSIVE CANCELLATION LIST POLAR DECODING

(71) Applicant: QUALCOMM Incorporated, San Diego, CA (US)

(72) Inventors: Debarnab MITRA, San Diego, CA (US); Solmaz NIKNAM, Sunnyvale, CA (US); Seyyed Ali HASHEMI, San Jose, CA (US); Hobin KIM, San Diego, CA (US); Hari SANKAR, San Diego, CA (US); Wei YANG, San Diego, CA (US); Jing JIANG, San Diego, CA (US)

(21) Appl. No.: 18/811,556

(22) Filed: Aug. 21, 2024

(51) Int. Cl. H04L 1/00

(52) U.S. Cl. CPC H04L 1/0045

(57) ABSTRACT

Methods, systems, and devices for wireless communications are described. A wireless device may receive a signal including a polar encoded control message. A message payload of the polar encoded control message may be associated with known bits information that may indicate one or more bit positions of one or more known bits and a respective bit value for each of the one or more known bits. The wireless device may perform successive cancellation list polar decoding on the signal to obtain the message payload of the polar encoded control message by generating list decoding bit sequences. A path metric of a list decoding bit sequence may be based on application of a bias penalty value to one or more bit decisions in the list decoding bit sequence that differ from a known bit value at a bit position in accordance with the known bits information.

### FIELD OF TECHNOLOGY

The following relates to wireless communications, including soft-biased successive cancellation list (SCL) polar decoding.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless device is described. The method may include receiving a first signal including a first polar encoded control message, where a message payload of the first polar encoded control message is associated with known bits information, the known bits information indicating one or more bit positions of one or more known bits and a respective bit value for each of the one or more known bits and performing successive cancellation list (SCL) polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

A wireless device for wireless communications is described. The wireless device may include one or more memories storing processor executable code, and one or more processors coupled with the one or more memories. The one or more processors may individually or collectively be operable to execute the code to cause the wireless device to receive a first signal including a first polar encoded control message, where a message payload of the first polar encoded control message is associated with known bits information, the known bits information indicating one or more bit positions of one or more known bits and a respective bit value for each of the one or more known bits and perform SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Another wireless device for wireless communications is described. The wireless device may include means for receiving a first signal including a first polar encoded control message, where a message payload of the first polar encoded control message is associated with known bits information, the known bits information indicating one or more bit positions of one or more known bits and a respective bit value for each of the one or more known bits and means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

A non-transitory computer-readable medium storing code for wireless communications is described. The code may include instructions executable by one or more processors to receive a first signal including a first polar encoded control message, where a message payload of the first polar encoded control message is associated with known bits information, the known bits information indicating one or more bit positions of one or more known bits and a respective bit value for each of the one or more known bits and perform SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Some examples of the method, wireless devices, and non-transitory computer-readable medium described herein may further include operations, features, means, or instructions for receiving a set of multiple control messages, where the known bits information may be based on the set of multiple control messages.

In some examples of the method, wireless devices, and non-transitory computer-readable medium described herein, the bias penalty value may be based on a quantity of known bits having a same bit value at a respective bit position across a set of multiple control messages.

In some examples of the method, wireless devices, and non-transitory computer-readable medium described herein, the bias penalty value biases the one or more bit decisions in the first list decoding bit sequence towards a first bit value based on a quantity of known bits having a same bit value at a respective bit position across a set of multiple control messages.

In some examples of the method, wireless devices, and non-transitory computer-readable medium described herein, the bias penalty value biases the one or more bit decisions in the first list decoding bit sequence towards a second bit value based on a quantity of known bits having a same bit value at a respective bit position across a set of multiple control messages.

In some examples of the method, wireless devices, and non-transitory computer-readable medium described herein, bits of a previously received control message may be stored in an interleaved state as at least a portion of the known bits information based on the bits of the previously received control message passing a cyclic redundancy check (CRC).

Some examples of the method, wireless devices, and non-transitory computer-readable medium described herein may further include operations, features, means, or instructions for receiving one or more control messages, where the bias penalty value may be based on a ratio of a quantity of bits of the one or more control messages having a first bit value and a total quantity of bits of the one or more control messages.

Some examples of the method, wireless devices, and non-transitory computer-readable medium described herein may further include operations, features, means, or instructions for receiving an indication of a table that indicates one or more bias penalty values to apply to one or more bit decisions, where the SCL polar decoding may be performed in accordance with the table.

Some examples of the method, wireless devices, and non-transitory computer-readable medium described herein may further include operations, features, means, or instructions for receiving a control message indicating the bias penalty value.

A method for wireless communications by a wireless device is described. The method may include receiving a first signal including a first polar encoded control message, where a message payload of the first polar encoded control message is associated with known bits information, the known bits information indicating one or more bit positions of one or more known bits and a respective bit value for each of the one or more known bits, applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information, and performing SCL polar decoding on the set of multiple biased codeword bits to obtain the message payload of the first polar encoded control message.

A wireless device for wireless communications is described. The wireless device may include one or more memories storing processor executable code, and one or more processors coupled with the one or more memories. The one or more processors may individually or collectively be operable to execute the code to cause the wireless device to receive a first signal including a first polar encoded control message, where a message payload of the first polar encoded control message is associated with known bits information, the known bits information indicating one or more bit positions of one or more known bits and a respective bit value for each of the one or more known bits, apply a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information, and perform SCL polar decoding on the set of multiple biased codeword bits to obtain the message payload of the first polar encoded control message.

Another wireless device for wireless communications is described. The wireless device may include means for receiving a first signal including a first polar encoded control message, where a message payload of the first polar encoded control message is associated with known bits information, the known bits information indicating one or more bit positions of one or more known bits and a respective bit value for each of the one or more known bits, means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information, and means for performing SCL polar decoding on the set of multiple biased codeword bits to obtain the message payload of the first polar encoded control message.

A non-transitory computer-readable medium storing code for wireless communications is described. The code may include instructions executable by one or more processors to receive a first signal including a first polar encoded control message, where a message payload of the first polar encoded control message is associated with known bits information, the known bits information indicating one or more bit positions of one or more known bits and a respective bit value for each of the one or more known bits, apply a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information, and perform SCL polar decoding on the set of multiple biased codeword bits to obtain the message payload of the first polar encoded control message.

In some examples of the method, wireless devices, and non-transitory computer-readable medium described herein, a second value of the set of multiple bias values may be applied to a second codeword bit of the set of multiple codeword bits based on known bit values for bit positions in the message payload in accordance with the known bits information.

Some examples of the method, wireless devices, and non-transitory computer-readable medium described herein may further include operations, features, means, or instructions for applying a second bias value of the set of multiple bias values to one or more CRC bits of the first polar encoded control message to obtain one or more biased CRC bits, where SCL polar decoding may be performed based on the one or more biased CRC bits.

In some examples of the method, wireless devices, and non-transitory computer-readable medium described herein, a second bias value of the set of multiple bias values associated with a frozen bit of the first polar encoded control message differs from a third bias value of the set of multiple bias values associated with a data bit of the first polar encoded control message.

In some examples of the method, wireless devices, and non-transitory computer-readable medium described herein, the third bias value may be based on bias values of the set of multiple bias values associated with a set of multiple data bits of the message payload after CRC interleaving and bit mapping.

In some examples of the method, wireless devices, and non-transitory computer-readable medium described herein, the message payload may have a fixed payload size.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports soft-biased successive cancellation list (SCL) polar decoding in accordance with one or more aspects of the present disclosure.

FIG. 2 shows an example of a wireless communications system that supports soft-biased SCL polar decoding in accordance with one or more aspects of the present disclosure.

FIG. 3 shows an example of a decoding diagram that supports soft-biased SCL polar decoding in accordance with one or more aspects of the present disclosure.

FIG. 4 shows an example of a decoding process that supports soft-biased SCL polar decoding in accordance with one or more aspects of the present disclosure.

FIG. 5 shows an example of a process flow that supports soft-biased SCL polar decoding in accordance with one or more aspects of the present disclosure.

FIGS. 6 and 7 show block diagrams of devices that support soft-biased SCL polar decoding in accordance with one or more aspects of the present disclosure.

FIG. 8 shows a block diagram of a communications manager that supports soft-biased SCL polar decoding in accordance with one or more aspects of the present disclosure.

FIG. 10 shows a diagram of a system including a UE that supports soft-biased SCL polar decoding in accordance with one or more aspects of the present disclosure.

FIG. 9 shows a diagram of a system including a network entity that supports soft-biased SCL polar decoding in accordance with one or more aspects of the present disclosure.

FIGS. 11 through 13 show flowcharts illustrating methods that support soft-biased SCL polar decoding in accordance with one or more aspects of the present disclosure.

### DETAILED DESCRIPTION

In some wireless communications systems, a transmitting device may polar encode a message and transmit the polar encoded message to a receiving device. For example, the transmitting device may encode one or more control messages (e.g., downlink control information (DCI) messages) to transmit to the receiving device. The receiving device may use successive cancellation list (SCL) polar decoding to decode the polar encoded message, which involves generating multiple list decoding bit sequences that are each associated with a path metric (e.g., an indication of the likelihood that the list decoding bit sequence is the bit sequence originally encoded by the transmitting device). In some cases, one or more bit positions (e.g., known bits) in the polar encoded message may have a same value across multiple messages. For example, a field in a DCI message indicating an intended receiving device may be the same for multiple DCI messages received by a same receiving device. In some examples, the receiving device may employ a hard-bias decoder (e.g., a hard-decision decoder), in which each bit is decoded as either a binary 1 or a binary 0 (e.g., using a threshold). In contrast, a soft-bias decoder (e.g., a soft-decision decoder) may consider a range of possible values or may consider additional information (e.g., a log-likelihood ratio (LLR) value) from a stream of bits to indicate a reliability of each bit in a list decoding bit sequence, and improve performance relative to the hard-bias decoder in the presence of corrupted data (e.g., noise in the channel changes a 0 to a 1, or vice versa). A method for soft-bias decoding using known bits information from one or more previous polar encoded control messages may be desired to improve performance and increase decoding robustness in a wireless communications system.

In some implementations, a receiving device may store known bits information associated with one or more control messages. The known bits information may indicate the bit positions and respective bit values of known bits that have a same bit value across each of the one or more control messages. The receiving device may use the known bits information to improve the decoding of a subsequent polar encoded control message. For example, the receiving device may perform SCL polar decoding on the subsequent polar encoded control message by generating a set of list decoding bit sequences (e.g., potential bit sequences that may be the correct message payload). Each list decoding bit sequence may be associated with a path metric that indicates how likely each list decoding bit sequence is to be the correct message payload. The receiving device may adjust the path metrics of one or more list decoding bit sequences via application of a bias penalty value such that one or more bit decisions in the list decoding bit sequences that differ from one or more known bit values at one or more known bit positions in at least one previous control message may be penalized. Methods for generating and applying the bias penalty value based on the known bits information are described.

Particular aspects of the subject matter described herein may be implemented to realize one or more potential advantages. The described techniques may provide for improved communication reliability, reduced latency, reduced processing, improved user experience related to reduced processing, more efficient utilization of communication resources, and improved coordination between devices. For example, the receiving device may leverage information about previous control messages to improve decoding performance at low signal-to-noise ratios (SINRs) by applying a bias penalty value to bit sequences that have one or more bit decision values at bit positions that differ from bit values received in one or more previous control messages at certain bit positions. This may reduce instances of decoding failures and transmission of negative acknowledgments (NACKs).

Aspects of the disclosure are initially described in the context of wireless communications systems. Aspects of the disclosure are then described in the context of a decoding diagram, a decoding process, and a process flow. Aspects of the disclosure are further illustrated by and described with reference to apparatus diagrams, system diagrams, and flowcharts that relate to soft-biased SCL polar decoding.

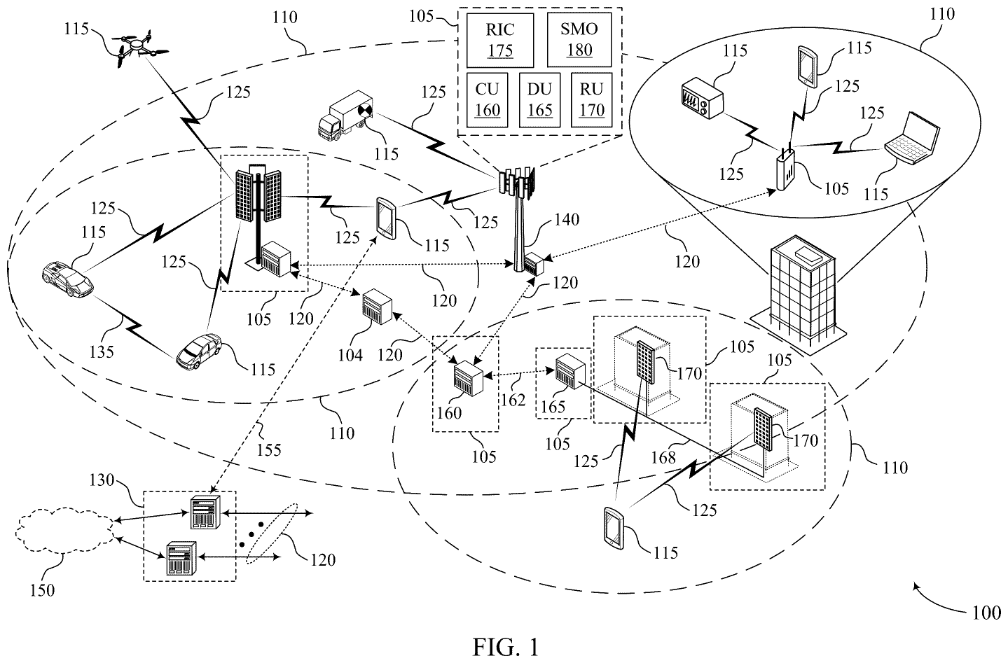

FIG. 1 shows an example of a wireless communications system 100 that supports soft-biased SCL polar decoding in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems, a transmitting device (which may be a network entity 105, a UE 115, or another type of device in the wireless communications system 100) may polar encode a message and transmit (e.g., via a communication link 125) the polar encoded message to a receiving device (e.g., which may also be a network entity 105, a UE 115, or another type of device in the wireless communications system 100). For example, the transmitting device may encode one or more control messages (e.g., DCI messages) to transmit to the receiving device. The receiving device may use SCL polar decoding to decode the polar encoded message, which involves generating multiple list decoding bit sequences that are each associated with a path metric (e.g., an indication of the likelihood that the list decoding bit sequence is the bit sequence originally encoded by the transmitting device). In some cases, one or more bit positions (e.g., known bits) in the polar encoded message may have a same value across multiple messages. For example, a field in a DCI message indicating an intended receiving device may be the same for multiple DCI messages received by a same receiving device. In some examples, the receiving device may employ a hard-bias decoder (e.g., a hard-decision decoder), in which each bit is decoded as either a binary 1 or a binary 0 (e.g., using a threshold). In contrast, a soft-bias decoder (e.g., a soft-decision decoder) may consider a range of possible values or may consider additional information (e.g., an LLR value) from a stream of bits to indicate a reliability of each bit in a list decoding bit sequence, and improve performance relative to the hard-bias decoder in the presence of corrupted data (e.g., noise in the channel changes a 0 to a 1, or vice versa). A method for soft-bias decoding using known bits information from one or more previous polar encoded control messages may be desired to improve performance and increase decoding robustness in a wireless communications system.

In some implementations, a receiving device may store known bits information associated with one or more control messages. The known bits information may indicate the bit positions and respective bit values of known bits that have a same bit value (or are likely to have a same bit value) across each of the one or more control messages. The receiving device may use the known bits information to improve the decoding of a subsequent polar encoded control message. For example, the receiving device may perform SCL polar decoding on the subsequent polar encoded control message by generating a set of list decoding bit sequences (e.g., potential bit sequences that may be the correct message payload). Each list decoding bit sequence may be associated with a path metric that indicates how likely each list decoding bit sequence is to be the correct message payload. The receiving device may adjust the path metrics of one or more list decoding bit sequences via application of a bias penalty value such that one or more bit decisions in the list decoding bit sequences that differ from one or more known bit values at one or more known bit positions in at least one previous control message may be penalized.

Particular aspects of the subject matter described herein may be implemented to realize one or more potential advantages. The described techniques may provide for improved communication reliability, reduced latency, reduced processing, improved user experience related to reduced processing, more efficient utilization of communication resources, and improved coordination between devices. For example, the receiving device may leverage information about previous control messages to improve decoding performance at low signal-to-noise ratios (SINRs) by applying a bias penalty value to bit sequences that have one or more bit decision values at one or more bit positions that differ from one or more bit values received in one or more previous control messages at certain bit positions. This may reduce instances of decoding failures and transmission of negative acknowledgments (NACKs).

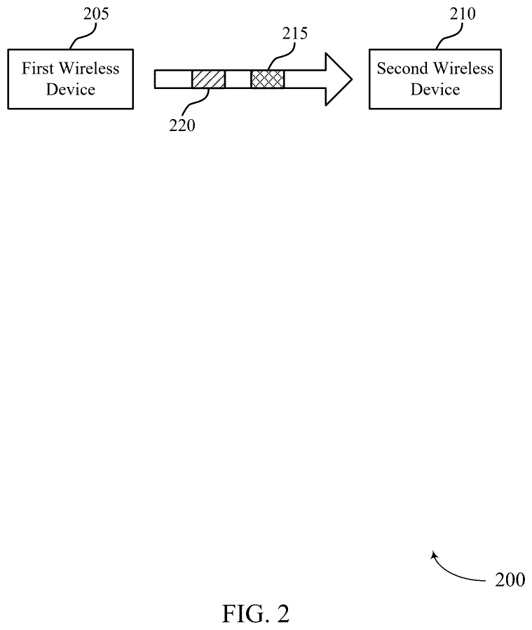

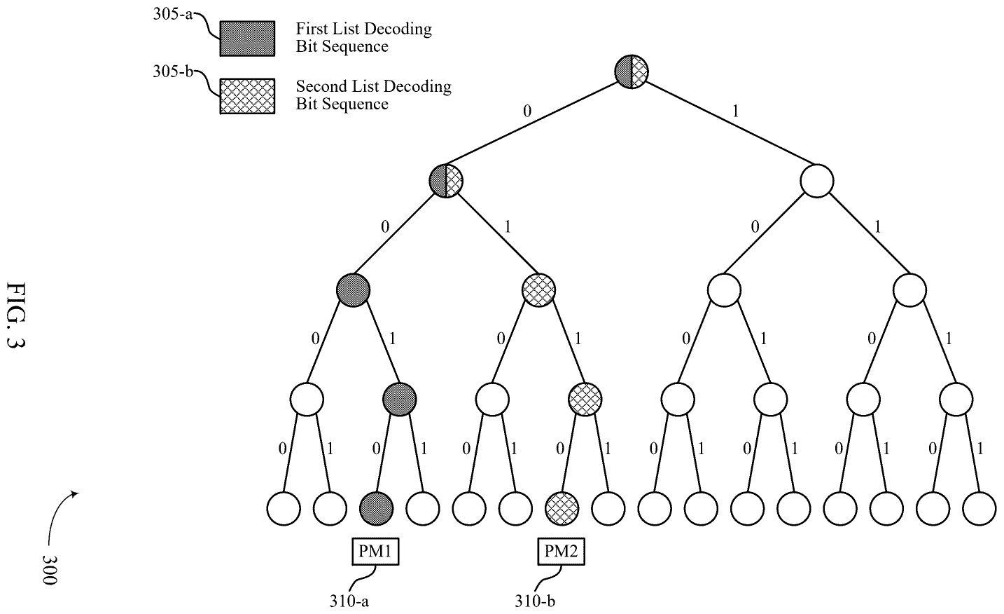

FIG. 2 shows an example of a wireless communications system 200 that supports soft-biased SCL polar decoding in accordance with one or more aspects of the present disclosure. In some examples, the wireless communications system 200 may implement aspects of the wireless communications system 100. For example, the wireless communications system 200 includes a first wireless device 205 and a second wireless device 210, which may each be examples of a network entity 105 and a UE 115 described with reference to FIG. 1. Additionally, or alternatively, the first wireless device 205 and the second wireless device 210 may each be examples of other types of wireless devices, such as an IAB node or another type of transmitter or receiver. As described herein, operations performed by the first wireless device 205 and the second wireless device 210 may be respectively performed by a UE 115, a network entity 105, or another wireless device, and the examples shown should not be construed as limiting.

Devices in the wireless communications system 200 may support SCL decoding for polar codes that may be used, e.g., for control channel processing (CCHP) of 5G and other radio access technologies. For example, the first wireless device 205 may transmit a first signal including one or more first polar encoded control messages 215 to the second wireless device 210, and may subsequently transmit a second signal including a polar encoded control message 220. The second wireless device 210 may perform SCL polar decoding on the first signal to obtain the message payload of the polar encoded control message 220 by generating multiple list decoding bit sequences (e.g., a list of candidate bit sequences). Each list decoding bit sequence may be associated with a path metric to indicate a likelihood that the list decoding bit sequence is correct bit sequence encoded by the first wireless device 205. For example, an output of a decoder associated with the second wireless device 210 may be the list decoding bit sequence with the largest or the smallest path metric. In some implementations, the second wireless device 210 may modify the path metric of one or more list decoding bit sequences (e.g., add bias to different paths) in the list of candidate bit sequences in accordance with a priori knowledge of one or more values of individual bits in the message payload, a priori knowledge of a distribution of bits in the message payload (e.g., knowledge that certain bits are more likely to have a value of binary 0 than a value of binary 1), or a combination thereof.

For example, the second wireless device 210 may generate known bits information associated with the one or more first polar encoded control messages 215 (e.g., which may be associated with a physical downlink control channel (PDCCH)). For instance, the second wireless device 210 may find the known bits from the raw message payloads of two consecutive grants (e.g., two of the first polar encoded control messages 215 that may share a same control message format, a same radio network temporary identifier (RNTI) type, or both). That is, the known bits may be one or bit locations whose bit value remains unchanged from a first grant (e.g., in slot n) to at least a second grant (e.g., in slot n+1) preceding the polar encoded control message 220 (e.g., in slot n+2). For example, the one or more first polar encoded control messages 215 may be DCI messages directed to the second wireless device 210. There may be a field in the DCI messages indicating a target device (e.g., receiving device) for the DCI messages. Thus, the one or more first polar encoded control messages 215 received by the second wireless device 210 may each have the same value in that field (e.g., at that bit location). The second wireless device 210 may then compare the known bits with a corresponding bit in a third grant (e.g., the polar encoded control message 220) and count a quantity of matched bits (e.g., one or more bits in the polar encoded control message 220 that share a same value at respective bit positions in the one or more first polar encoded control messages 215). Because one or more known bits may have a same value across multiple control messages, the decoder of the second wireless device 210 may use the known bits information to improve the decoding performance.

In some examples, the second wireless device 210 may compare the one or more first polar encoded control messages 215 bit-by-bit over up to the whole message payload. In some other examples, the second wireless device 210 may compare the one or more first polar encoded control messages 215 on individual fields from the parsed control messages of two or more consecutive grants. The second wireless device 210 may decode the polar encoded control message 220 using one or more known bits from one of three categories: a subset of known bits with a value of binary 0, a subset of known bits with a value of binary 1, and the set of known bits having a value of either binary 0 or binary 1 (e.g., all known bits). In some examples CCHP polar codes (e.g., in 5G), a quantity of bits may be frozen bits set to a value of binary 0, and therefore, handling bits of value binary 0 may be simpler (e.g., from a hardware perspective). In other words, a hard-bias decoder may decide that a first bit has a value of binary 0 and may “freeze” that first bit to a value of binary 0 (e.g., may no longer consider any possibilities that the first bit has a value of binary 1). In cases where the first bit is incorrectly marked as 0, such a hard-bias decoder will always be incorrect.

Polar decoding may be divided into two phases: phase 1 polar decoding and phase 2 polar decoding. For example, if no hypothesis passes from phase 1 polar decoding, the second wireless device 210 may perform phase 2 polar decoding using known bits information from firmware. The known bits information from firmware may contain the indices (e.g., the bit positions) of the known bits in the message payload and the corresponding value of the known bits (e.g., a binary 0 or a binary 1). In some examples, phase 2 polar decoding may only run for limited aggregation levels and K sizes (e.g., where K is a constraint length) based on a previous grant (e.g., the one or more first polar encoded control messages 215). For example, if the previous grants (e.g., the one or more first polar encoded control messages 215), which provide the known bits, have an aggregation level of 2 and a DCI format 1-1, then phase 2 polar decoding may be limited to the same aggregation level of 2 and the same DCI format 1-1. Implementations discussed in the present disclosure may describe phase 2 polar decoding for improving performance without concerning power, and thus early termination (e.g., LLR-based, path metric-based) may be disabled in phase 2 polar decoding.

In some implementations, the second wireless device 210 may use a soft-bias SCL decoder to decode the message payload of the polar encoded control message 220. For example, the second wireless device 210 may bias the SCL decoder based on the known bits information from firmware. Table 1 depicts how a hard-bias decoder may apply a hard bias penalty value to one or more path metrics based on known bits information. For example, if the bit value at a first known bit position is known to be binary 0, but the SCL bit decision at that bit position is binary 1, the hard-bias decoder may apply a maximum LLR value (e.g., infinity) to the path metric associated with that bit decision. For a given data leaf node, the LLR value may be an incoming log-likelihood message in the SCL decoder. That is, the LLR value may be a likelihood that a particular bit has a first value (e.g., binary 0) or a second value (e.g., binary 1). If the LLR value is positive for a particular bit, the “LLR Positive” column of Table 1 may be used. Similarly, if the LLR value is negative for a particular bit, the “LLR Negative” column of Table 1 may be used. In some cases, a hard-bias SCL decoder may experience significant performance loss when one or more of the known bits are incorrectly predicted by firmware (e.g., significantly greater PDCCH block error rate (BLER)).

TABLE 1
SCL Decoder with Hard Bias

| | SCL Bit Decision | LLR Positive | LLR Negative |
|---|---|---|---|
| Known 0 | 0 | No Penalty | \|LLR\| |
| | 1 | MAX_LLR | MAX_LLR |
| Known 1 | 0 | MAX_LLR | MAX_LLR |
| | 1 | \|LLR\| | No Penalty |

In contrast, Table 2 depicts how a soft-bias SCL decoder may apply a soft bias penalty value to one or more path metrics based on known bits information. For example, the SCL decoder may add a bias penalty value (e.g., a value of P) to one or more path metrics in accordance with Table 2. The bias penalty value P may be added at each data leaf node based on the SCL bit decision of the node and based on the known bits information (e.g., whether the data leaf node is known-0 or known-1). If the LLR value is positive for a particular bit, the “LLR Positive” column of Table 2 may be used. Similarly, if the LLR value is negative for a particular bit, the “LLR Negative” column of Table 2 may be used. Depending on the scenario, the second wireless device 210 may maximize or minimize the path metric to produce a decoded message payload of the polar encoded control message 220, and may add or subtract the bias penalty value P accordingly. In some examples, the soft-bias SCL decoder of Table 2 may be more robust and may improve performance relative to the hard-bias SCL decoder of Table 1 (e.g., where P=∞) in cases of incorrectly predicted known bits.

TABLE 2
SCL Decoder with Soft Bias

| | SCL Bit Decision | LLR Positive | LLR Negative |
|---|---|---|---|
| Known 0 | 0 | No Penalty | \|LLR\| |
| | 1 | \|LLR\| + P | P |
| Known 1 | 0 | P | \|LLR\| + P |
| | 1 | \|LLR\| | No Penalty |

In some examples, the second wireless device 210 may select a value of the bias penalty value P based on an expected percentage of wrong bits p. in the known bits information from firmware. For example, the bias penalty value P may be calculated by Equation 1. Using Equation 1, the bias penalty value may be relatively large when the second wireless device 210 expects a relatively low percentage of incorrect bits in the known bits information (e.g., at low PDCCH BLER conditions), and the bias penalty value P may be relatively small when the second wireless device 210 expects a relatively high percentage of incorrect bits in the known bits information (e.g., at high PDCCH BLER conditions).

$$P = ln \frac{1 - p}{p} = ln \frac{\# knownBits - \# wrongBits}{\# wrongBits} \qquad Equation l$$

In some cases (e.g., as indicated by log data analysis), there may be high correlation between consecutive control messages (e.g., consecutive DCI messages, such as the one or more first polar encoded control messages 215). If a control message of the one or more first polar encoded control messages 215 passes a CRC, the second wireless device 210 may store a quantity of bits in an interleaved state as known bits to be used later by the SCL polar decoder. For example, for two or more polar encoded control messages 215, the second wireless device 210 may calculate a quantity of unchanged bits (e.g., bits whose value is the same at respective bit positions across the two or more polar encoded control messages 215) by performing an XOR operation on the two or more polar encoded control messages 215 and counting a quantity of bits with a first bit value (e.g., binary 0) and a quantity of bits with a second bit value (e.g., binary 1).

The second wireless device 210 may use the known bits information associated with the known bits from the one or more polar encoded control messages 215 to determine a soft bias penalty value P. For example, the second wireless device 210 may calculate a percentage of known bits with a first value (e.g., binary 1) using Equation 2. In some examples, the “quantity of 1's” in Equation 2 may refer to a quantity of known bits with a value of binary 1 (e.g., bits that have the value of 1 across multiple polar encoded control messages 215). The second wireless device 210 may then calculate the bias penalty value P as the natural logarithm of the ratio between a percentage of known bits with a second value (e.g., binary 0) and the percentage of known bits with the first value, as shown in Equation 3. In some examples, if

$$p = \frac{1}{2} ,$$

then the bias penalty value P=0 and the SCL polar decoder is unbiased. In some other examples, the bias penalty value P may bias one or more bit decisions in a list decoding bit sequence towards a first bit value based on the known bits information. For example, if

$$p > \frac{1}{2}$$

(e.g., based on a quantity of known bits having a same bit value at a respective bit position across multiple polar encoded control messages 215), then the bias penalty value P<0 and the SCL polar decoder is biased towards the first value at the respective bit position in the polar encoded control message 220. Similarly, the bias penalty value may bias one or more bit decisions in a list decoding bit sequence towards a second bit value based on a quantity of known bits having a same bit value at a respective bit position across multiple polar encoded control messages 215. For example, if

$$p < \frac{1}{2} ,$$

then the bias penalty value P>0 and the SCL polar decoder is biased towards the second value at the respective bit position in the polar encoded control message 220. Using the previously stored known bits (e.g., known-0 or known-1 based on the control message value), the second wireless device 210 may decode the polar encoded control message 220 according to Table 2 and Equations 2 and 3. For example, the second wireless device 210 may apply the bias value P at known bit positions associated with known bit values from the one or more polar encoded control messages 215 according to Table 2.

$$p = \frac{quantity of 1 ' s}{total quantity of bits} \qquad Equation 2$$

$$P = ln \frac{1 - p}{p} \qquad Equation 3$$

Additionally, or alternatively, the second wireless device 210 may calculate the bias penalty value P (e.g., to be applied during the decoding of the polar encoded control message 220) based on one or more polar encoded control messages 215. For example, a first quantity of bits in the one or more polar encoded control messages 215 with a first value (e.g., binary 1) may generally be smaller than a second quantity of bits in the one or more polar encoded control messages 215 with a second value (e.g., binary 0). The second wireless device 210 may calculate the bias penalty value P using Equations 2 and 3, where the “quantity of 1's” may refer to a quantity of bits in the one or more polar encoded control messages 215 with the first value.

In some cases, the bias penalty value P may be based on a single preceding control message (e.g., a DCI message). For example, a first polar encoded control message 215 may have a message payload of 01101011 (e.g., 3 bits with a value of binary 0 and 5 bits with a value of binary 1, for a total payload length of 8 bits). Using Equations 2 and 3,

$$p = \frac{5 bits}{8 bits} = 0.625$$

and the bias penalty value

$$P = ln \frac{1 - 0.625}{0.625} \approx - 0.51 \; 1 .$$

Thus, based on the first polar encoded control message 215 (and no additional control messages) having more 1's than 0's in the message payload, the second wireless device 210 may bias the decoding of one or more bits of the polar encoded control message 220 (which may immediately follow the first polar encoded control message 215) towards a value of binary 1. In such cases, the bias penalty value P may be different for each consecutive control message (e.g., more dynamic than changing every 2 or more control messages). In some other cases, the bias penalty value P may be based on multiple preceding control messages (e.g., two or more DCI messages). For example, a first polar encoded control message 215 may have a message payload of 01101011 and a second polar encoded control message 215 may have a message payload of 00100010. Using Equations 2 and 3,

$$p = \frac{7 bits}{16 bits} = 0.4375$$

and the bias penalty value

$$P = ln \frac{1 - 0.4375}{0.4375} \approx 0.251 .$$

Thus, based on the first polar encoded control message 215 and the second polar encoded control message 215 having more 0's than 1's in the combined message payload, the second wireless device 210 may bias the decoding of one or more bits of the polar encoded control message 220 (which may immediately follow the first and second polar encoded control messages 215) towards a value of binary 0.

The second wireless device 210 may apply the bias penalty value P to one or more bits of the polar encoded control message 220 according to Table 3, based on a sign (e.g., positive or negative) of an LLR value and a P associated with the one or more bits (e.g., a bit position or index). That is, the second wireless device 210 may calculate one or more path metrics based on the bit decisions in the SCL decoder, an LLR value, and the sign (e.g., positive or negative) of the bias penalty value P in accordance with Table 3. In some examples, if

$$p = \frac{1}{2} ,$$

then P=0 and the SCL polar decoder is unbiased. If

$$p > \frac{1}{2} ,$$

then P<0 and the SCL polar decoder is biased towards the first value. If

$$p < \frac{1}{2} ,$$

then P>0 and the SCL polar decoder is biased towards the second value

TABLE 3
SCL Polar Decoder

| SCL Bit | LLR Positive | | LLR Negative | |
|---|---|---|---|---|
| Decision | Positive P | Negative P | Positive P | Negative P |
| 0 | 0 | \|P\| | \|LLR\| | \|LLR\| + P |
| 1 | \|LLR\| + P | \|LLR\| | P | 0 |

Since the SCL polar decoder of the second wireless device 210 is a soft-bias SCL decoder, the bias value P may be added directly at the node level based on SCL bit decisions and the known bits information at the node level. In some examples, a firmware processor implementing the SCL polar decoder may compare the whole control message 215 and may provide the bias penalty value P by doing a bit-by-bit comparison. That is, the second wireless device 210 may avoid look up tables and expensive interleaving and bit mapping. Additionally, or alternatively, that second wireless device 210 may avoid finding individual fields, as the comparison is performed bit-by-bit.

In some examples, the second wireless device 210 may make a preliminary decision on whether a particular bit has a first value or a second value before the decoding process. For example, a first LLR value may correspond to a first bit value at a first bit position. The second wireless device 210 may add or subtract a bias value P to the LLR associated with the first bit value at the first bit position. For example, the second wireless device 210 may obtain one or more codeword bits from the polar encoded control message 220, and may convert the bias on the data leaf nodes to a bias on the one or more codeword bits λ₁, λ₂, . . . , λ_{N}, where N is the codeword length of the polar code. The second wireless device 210 may apply one or more bias penalty values to the one or more codeword bits to obtain one or more biased codeword bits. For example, the second wireless device 210 may add the bias on the codeword bits λ₁, λ₂, . . . , λ_{N} to the corresponding channel LLR values and then perform SCL polar decoding (e.g., without further use of the known bits information or bias values). This method may be advantageous because the second wireless device 210 may use the same hardware for the polar decoder core as used for an unbiased polar decoder.

The bias on the one or more message payload bits of the control message 220 obtained from firmware may be represented by μ₁, μ₂, . . . , μ_{A}, where A may be a quantity of bits in payload size of the message payload (e.g., a fixed payload size). In some examples, μ₁, μ₂, . . . , μ_{A} may be set according to the bias value P or to 0 (e.g., based on known bits information, based on one or more tables such as Tables 1, 2, or 3). Additionally, or alternatively, μ₁, μ₂, . . . , μ_{A} may be set to the bias value P. A bias value on one or more CRC bits may be represented by μ_{A+1}, μ_{A+2}, . . . , μ_{K}, and may be found from μ₁, μ₂, . . . , μ_{A} by performing one iteration of belief propagation where the adjacency matrix is provided by the parity check equations of the CRC code.

The bias values on the leaf nodes in the SCL polar decoder of the second wireless device 210 may be represented by Π₁, Π₂, . . . Π_{N}. If a leaf node i is a frozen bit, the bias value Πᵢ=∞ (or a maximum LLR value, MAX_LLR). If a leaf node i is a data leaf node (e.g., a message payload bit or a CRC bit), then the second wireless device 210 may obtain the bias value Πᵢ from μ₁, μ₂, . . . , μ_{A} after CRC interleaving and bit mapping. The bias on the codeword bits λ₁, λ₂, . . . , λ_{N} may be found from the bias values of the leaf nodes Π₁, Π₂, . . . Π_{N} by performing one iteration of belief propagation where the adjacency matrix is given by the G matrix of the polar code.

Stated another way, the second wireless device 210 may apply one or more bias values (e.g., P) to one or more codeword bits obtained from the polar encoded control message 220 to obtain one or more biased codeword bits. For example, a first bias value may be applied to a first codeword bit based on known bit values for bit positions in the message payload in accordance with known bits information. In some examples, a second bias value may be applied to a second codeword bit based on known bit values for bit positions in the message payload in accordance with the known bits information. In some cases, the second wireless device 210 may apply a second bias value to one or more CRC bits of the polar encoded control message 220 to obtain one or more biased CRC bits. The second wireless device 210 may perform the SCL polar decoding of the polar encoded control message 220 based on the one or more biased CRC bits. In some examples, a second bias value associated with a frozen bit of the polar encoded control message 220 may differ from a third bias value associated with a data bit of the polar encoded control message 220. The third bias value may be based on bias values associated with one or more data bits of the message payload after CRC interleaving and bit mapping.

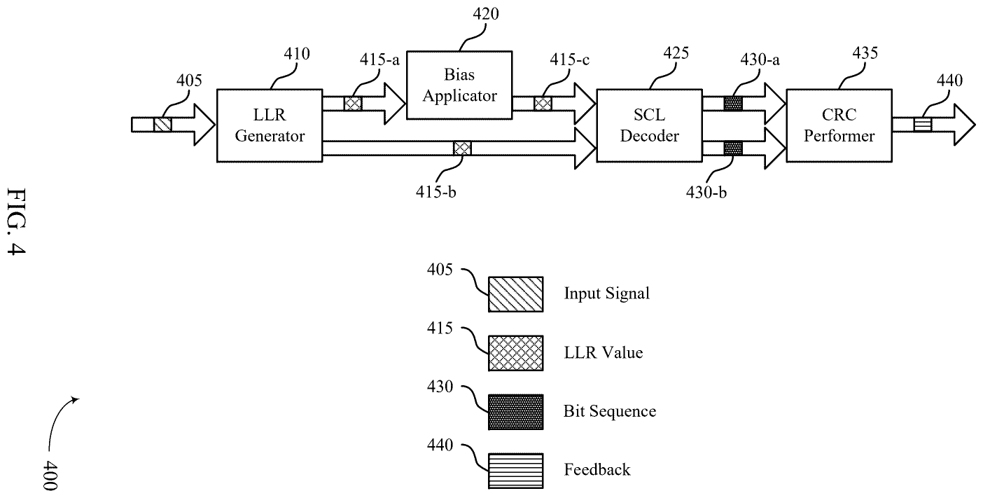

FIG. 3 shows an example of a decoding diagram 300 that supports soft-biased SCL polar decoding in accordance with one or more aspects of the present disclosure. The decoding diagram 300 may implement or be implemented by one or more aspects of the wireless communications system 100 and the wireless communications system 200 described with reference to FIGS. 1 and 2, respectively. For example, the decoding diagram 300 may be implemented by a receiving wireless device, which may be an example of a UE 115, a network entity 105, a second wireless device 210, or another device as described with reference to FIGS. 1 and 2 to support soft-biased SCL polar decoding.

For example, the decoding diagram 300 may be utilized during an example SCL polar decoding process at a receiving device. The receiving device may receive a polar encoded control message (e.g., a DCI message, or the polar encoded control message 220 as described with reference to FIG. 2) and may decode the polar encoded control message using known bits information from one or more preceding polar encoded control messages in accordance with the decoding diagram 300. For example, the receiving device may receive a first polar encoded control message that passes a cyclic redundancy check and a second polar encoded control message that passes a cyclic redundancy check. A first message payload of the first polar encoded control message may be 1010 and a second message payload of the second polar encoded control message may be 0000. The first message payload and the second message payload may include one or more known bits and one or more variable bits. The known bits (e.g., the bit values at the second bit position and the fourth bit position) may be unlikely to change across multiple control messages. Thus, the receiving wireless device may store known bits information associated with the known bits. Specifically, the known bits information may indicate a bit value of binary 0 at the second bit position and a bit value of binary 0 at the fourth position, based on receiving the first polar encoded control message and the second polar encoded control message.

Using the known bits information, the receiving device may SCL polar decode a third polar encoded control message by generating a quantity of list decoding bit sequences 305 that represent possible message payloads associated with the third polar encoded control message. For example, for a message payload with a payload length of 4 bits, a first list decoding bit sequence 305-a may be 0010 and a second list decoding bit sequence 305-b may be 0110. Each list decoding bit sequence may be associated with a respective path metric 310 that indicates a likelihood that the list decoding bit sequence is the message payload of the polar encoded control message. For example, the first list decoding bit sequence 305-a may be associated with a first path metric 310-a and the second list decoding bit sequence may be associated with a second path metric 310-b.

Each path metric 310 may be based on one or more bit decisions in the corresponding list decoding bit sequence 305. In some implementations, each path metric 310 may also be based on application of a bias penalty value P (e.g., as described in more detail with reference to FIG. 2) to one or more bit decisions in the respective list decoding bit sequence 305 that differ from a known bit value at a bit position in accordance with the known bit information. For example, based on the first polar encoded control message and the second polar encoded control message, the known bits information may indicate a bit value of binary 0 in the second bit position (e.g., bit index) of the 4-bit message payload. Since the first bit position is not indicated as a known bit by the known bits information (e.g., the first bit position is a variable bit), the first bit decision may be based on an LLR value associated with the received signal. However, at the second bit decision of the SCL polar decoder (e.g., a data leaf node), the receiving wireless device may apply a bias penalty value P to a bit decision of 1 (e.g., as is the case for the second list decoding bit sequence 305-b) because it differs from the known bits information at the second bit position. Thus, the second path metric 310-b may have a lower value than the first path metric 310-a (e.g., if a larger path metric 310 indicates a more likely message payload), and the first list decoding bit sequence 305-a is indicated as more likely to be the message payload of the polar encoded control message because it more closely resembles previous polar encoded control messages The value of the bias penalty value P may be calculated by one of the methods described with reference to FIG. 2.

FIG. 4 shows an example of a decoding process 400 that supports soft-biased SCL polar decoding in accordance with one or more aspects of the present disclosure. The decoding process 400 may implement or be implemented by one or more aspects of the wireless communications system 100, the wireless communications system 200, and the decoding diagram 300 described with reference to FIGS. 1, 2, and 3, respectively. For example, the decoding process 400 may be implemented by a receiving wireless device, which may be an example of a UE 115, a network entity 105, a second wireless device 210, or another device as described with reference to FIGS. 1 and 2 to support soft-biased SCL polar decoding.

For example, the decoding process 400 may be utilized by a receiving device to decode a polar encoded control message associated with known bits information. The known bits information may indicate one or more bit positions of one or more known bits and a respective bit value for each of the one or more known bits. The known bits information may be based on one or more preceding polar encoded control messages received by the receiving device. That is, The receiving device may receive and successfully decode (e.g., pass CRC) one or more polar encoded control messages (e.g., DCI messages). In some cases, a bit value at a particular bit position in may be the same for each of the one or more polar encoded control messages. Such bits may be referred to as known bits, and the receiving device may use the known bits information to bias the decoding of a next polar encoded control message.

In the decoding process 400, first an input signal 405 (e.g., the polar encoded control message) may enter an LLR generator 410. The LLR generator 410 may generate an LLR value 415 for each bit in the input signal. The LLR value 415 may indicate a likelihood that a particular bit has a first value (e.g., binary 1). Some of the bit positions of the input signal may be known bit positions associated with known bit values, while other bits may not be associated with known bit positions or known bit values (e.g., the bit value at these bit positions may differ across control messages). For example, a first LLR value 415-a may be associated with a first bit position that is associated with a known bit position while a second LLR value 415-b may be associated with a second bit position that is not associated with a known bit position. The bias applicator 420 may apply a bias value to the first LLR value 415-a to generate the biased LLR value 415-c (e.g., LLR+P) based on the known bits information. The receiving device may not apply a bias value to the second LLR value 415-b based on the known bits information.

The biased LLR value 415-c and the second LLR value 415-b may pass through the SCL decoder 425 to produce a first bit sequence 430-a and a second bit sequence 430-b, respectively. The first bit sequence 430-a and the second bit sequence 430-b may then pass through the CRC performer 435 to produce feedback 440. If the bit sequence 430-a matches the known bits information at the first bit position, the bit sequence 430-a is more likely to pass the cyclic redundancy check and produce an ACK in the feedback 440. If the bit sequence 430-a differs from the known bits information at the first bit position, then the bit sequence 430-a is more likely to fail the cyclic redundancy check and produce a NACK in the feedback 440.

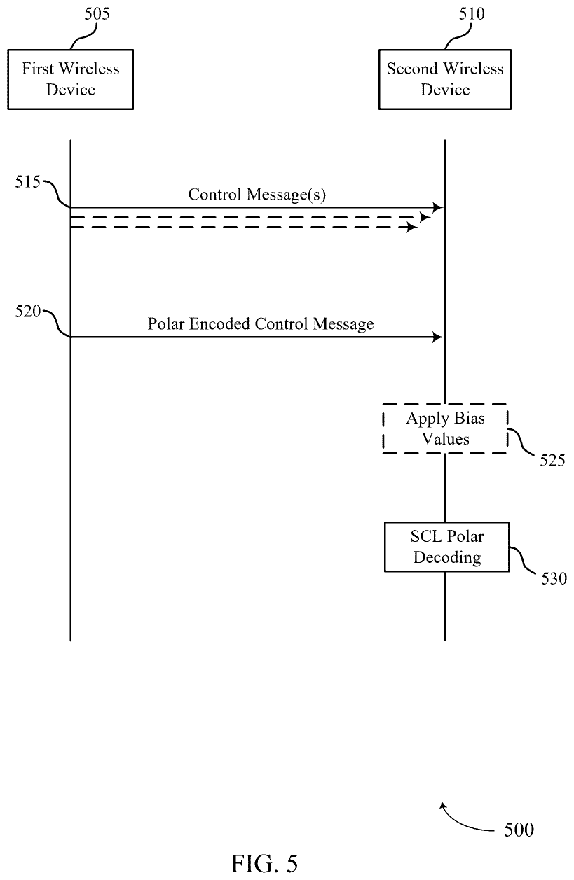

FIG. 5 shows an example of a process flow 500 that supports soft-biased SCL polar decoding in accordance with one or more aspects of the present disclosure. In some examples, the process flow 500 may be implemented by, or may implement aspects of, the wireless communications systems 100 and 200, the decoding diagram 300, and the decoding process 400. For example, the process flow 500 may be performed by a first wireless device 505 and a second wireless device 510, which may each be examples of a UE 115, a network entity 105, or another device as described with reference to FIGS. 1 and 2 to support soft-biased SCL polar decoding. Following the process flow 500, the second wireless device 510 may successively decode a control message payload received from the first wireless device 505 using known bit information from one or more preceding control messages. Alternative examples of the following may be implemented, where some steps are performed in a different order than described or are not performed at all. In some cases, steps may include additional features not mentioned below, or further steps may be added. Although the first wireless device 505 and the second wireless device 510 are shown performing the operations of the process flow 500, some aspects of some operations may also be performed by one or more other wireless devices.

At 515, the first wireless device 505 may transmit, and the second wireless device 510 may receive, one or more control messages (e.g., polar encoded control messages). In some examples, one or more bits may have a same value at one or more respective bit positions across the one or more control messages. Such bits may be referred to as known bits, and the second wireless device 510 may generate and store known bits information associated with one or more known bits of the one or more control messages for use in decoding a subsequent polar encoded control message (e.g., the polar encoded control message received at 520). In some examples, one or more bits of a control message received by the second wireless device 510 at 515 may be stored in an interleaved state as at least a portion of the known bits information based on the one or more bits of the control message passing a cyclic redundancy check.

In some examples, a bias penalty value (e.g., for use in decoding a subsequent control message, such as the polar encoded control message received at 520) may be based on a ratio of a quantity of bits of the one or more control messages having a first bit value and a total quantity of bits of the one or more control messages. In some examples, a control message received by the second wireless device 510 at 515 may indicate a bias penalty value that an SCL polar decoder of the second wireless device 510 may use to decode a subsequent polar encoded control message. For example, a control message received by the second wireless device 510 at 515 may include an indication of a table that indicates one or more bias penalty values for an SCL decoder of the second wireless device 510 to apply to one or more bit decisions. For example, the control message may indicate any of Table 1, Table 2, or Table 3 as described in more detail with reference to FIG. 2.

At 520, the first wireless device 505 may transmit, and the second wireless device 510 may receive, a signal including a polar encoded control message. A message payload of the polar encoded control message may be associated with known bits information. The known bits information may indicate one or more bit positions of one or more known bits and a respective bit value for each of the one or more known bits.

At 525, the second wireless device 510 (e.g., or an SCL decoder of the second wireless device 510) may apply one or more bias values to one or more codeword bits obtained from the polar encoded message at 520 to obtain one or more biased codeword bits. A first bias value of the one or more bias values may be applied to a first codeword bit of the one or more codeword bits based on known bit values for bit positions in the message payload in accordance with the known bits information. In some examples, the second wireless device 510 may apply a second value of the one or more bias values to a second codeword bit of the one or more codeword bits based on known bit values for bit positions in the message payload in accordance with the known bits information. In some examples, the second wireless device 510 may apply a second bias value of the one or more bias values to one or more CRC bits of the polar encoded control message to obtain one or more biased CRC bits. The second wireless device 510 may perform SCLR polar decoding based on the one or more biased CRC bits. In some cases, a second bias value of the one or more bias values associated with a frozen bit of the polar encoded control message differs from a third bias value of the one or more bias values associated with a data bit of the polar encoded control message. The third bias value may be based on bias values of the one or more bias values associated with one or more data bits of the message payload after CRC interleaving and bit mapping. In some examples, the message payload may have a fixed payload size (e.g., fixed quantity of bits A, where A is a positive integer).

At 530, the second wireless device 510 may perform SCL polar decoding on the signal received at 520 to obtain the message payload of the polar encoded control message. The SCL polar decoding may include generation of a set of multiple list decoding bit sequences. In some examples, a first path metric of a first list decoding bit sequence of the set of multiple list decoding bit sequences may be based on application of a bias penalty value to one or more bit decisions in the first list decoding bit sequence that differ from a known bit value at a bit position in accordance with the known bits information. In some cases, the bias penalty value may be based on a quantity of bits in the message payload. In some examples, the bias penalty value may be based on a quantity of known bits having a same bit value at a respective bit position across two or more control messages (e.g., two or more of the control messages received from the first wireless device 505 at 515). In some examples, the bias penalty value may bias the one or more bit decisions in the first list decoding bit sequence towards a first bit value (e.g., binary 0) based on a quantity of known bits having a same bit value at a respective bit position across two or more control messages (e.g., two or more of the control messages received from the first wireless device 505 at 515). In some examples, the bias penalty value may bias the one or more bit decisions in the first list decoding bit sequence towards a second bit value (e.g., binary 1) based on a quantity of known bits having a same bit value at a respective bit position across two or more control messages (e.g., two or more of the control messages received from the first wireless device 505 at 515).

In some examples, the second wireless device 510 may perform the SCL polar decoding in accordance with the received table that indicates one or more bias penalty values to apply to one or more bit decisions. For example, the second wireless device 510 may perform the SCL polar decoding in accordance with Table 1, Table 2, or Table 3 as described in more detail with reference to FIG. 2.

If the second wireless device 510 applied the one or more bias values to one or more codeword bits at 525, then the second wireless device 510 may perform SCL polar decoding on the one or more biased codeword bits to obtain the message payload of the polar encoded control message received at 520. In some examples, the second wireless device 510 may perform the SCL polar decoding based on the one or more biased CRC bits obtained at 525.

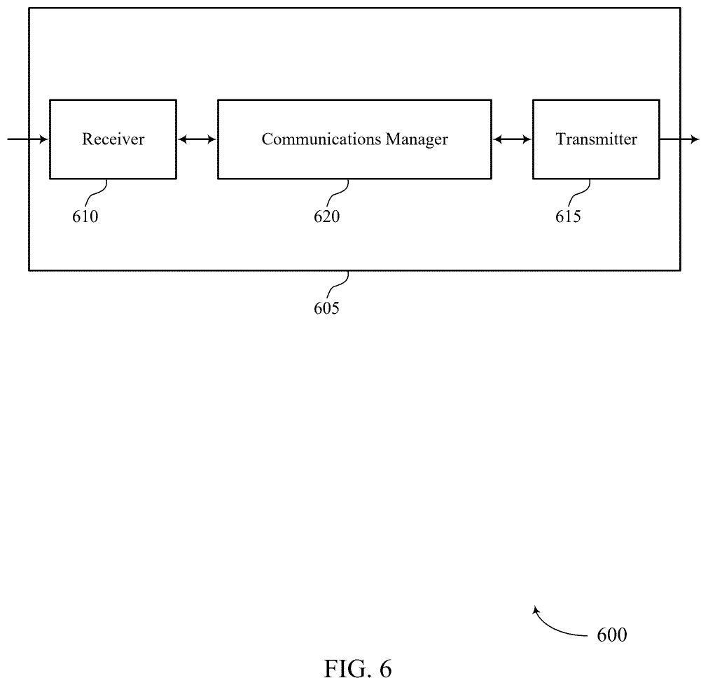

FIG. 6 shows a block diagram 600 of a device 605 that supports soft-biased SCL polar decoding in accordance with one or more aspects of the present disclosure. The device 605 may be an example of aspects of a UE 115 or a network entity 105 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to soft-biased SCL polar decoding). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to soft-biased SCL polar decoding). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of soft-biased SCL polar decoding as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 620 is capable of, configured to, or operable to support a means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Additionally, or alternatively, the communications manager 620 may support wireless communications in accordance with examples as disclosed herein. For example, the communications manager 620 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 620 is capable of, configured to, or operable to support a means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. The communications manager 620 is capable of, configured to, or operable to support a means for performing SCL polar decoding on the set of multiple biased codeword bits to obtain the message payload of the first polar encoded control message.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for reduced processing and more efficient utilization of communication resources.

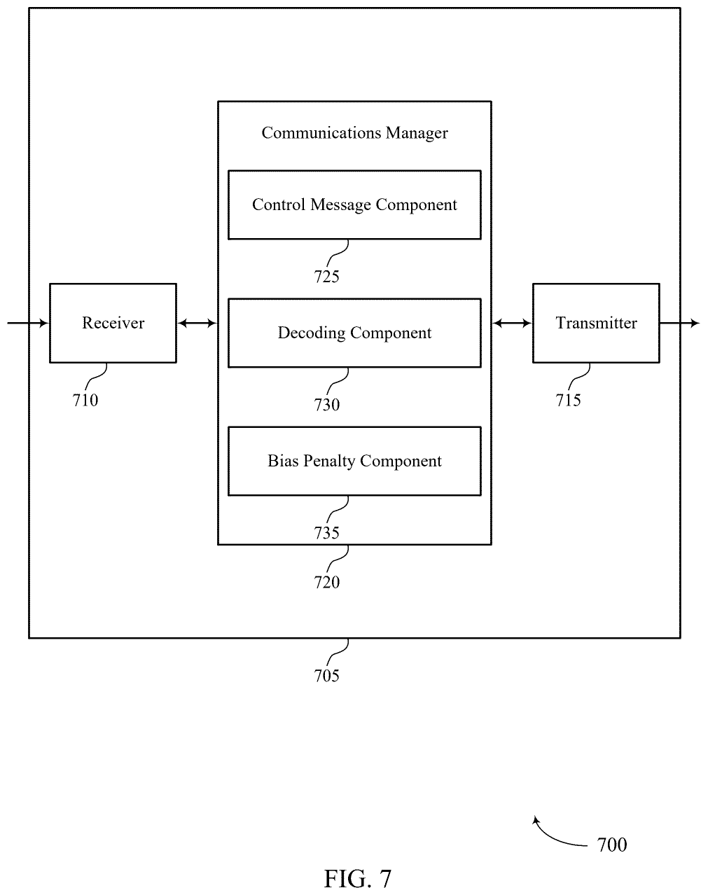

FIG. 7 shows a block diagram 700 of a device 705 that supports soft-biased SCL polar decoding in accordance with one or more aspects of the present disclosure. The device 705 may be an example of aspects of a device 605, a UE 115, or a network entity 105 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to soft-biased SCL polar decoding). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to soft-biased SCL polar decoding). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of soft-biased SCL polar decoding as described herein. For example, the communications manager 720 may include a control message component 725, a decoding component 730, a bias penalty component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control message component 725 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The decoding component 730 is capable of, configured to, or operable to support a means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Additionally, or alternatively, the communications manager 720 may support wireless communications in accordance with examples as disclosed herein. The control message component 725 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The bias penalty component 735 is capable of, configured to, or operable to support a means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. The decoding component 730 is capable of, configured to, or operable to support a means for performing SCL polar decoding on the set of multiple biased codeword bits to obtain the message payload of the first polar encoded control message.

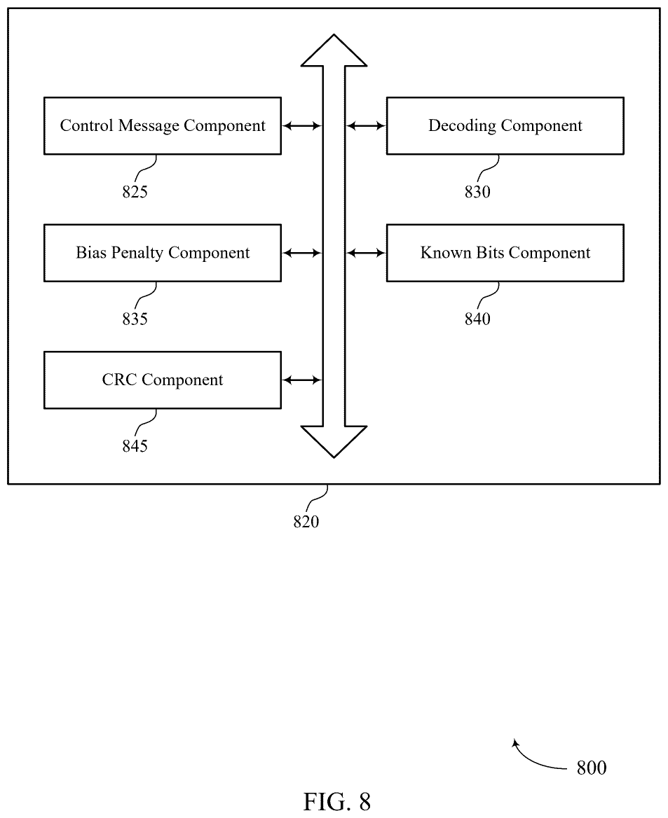

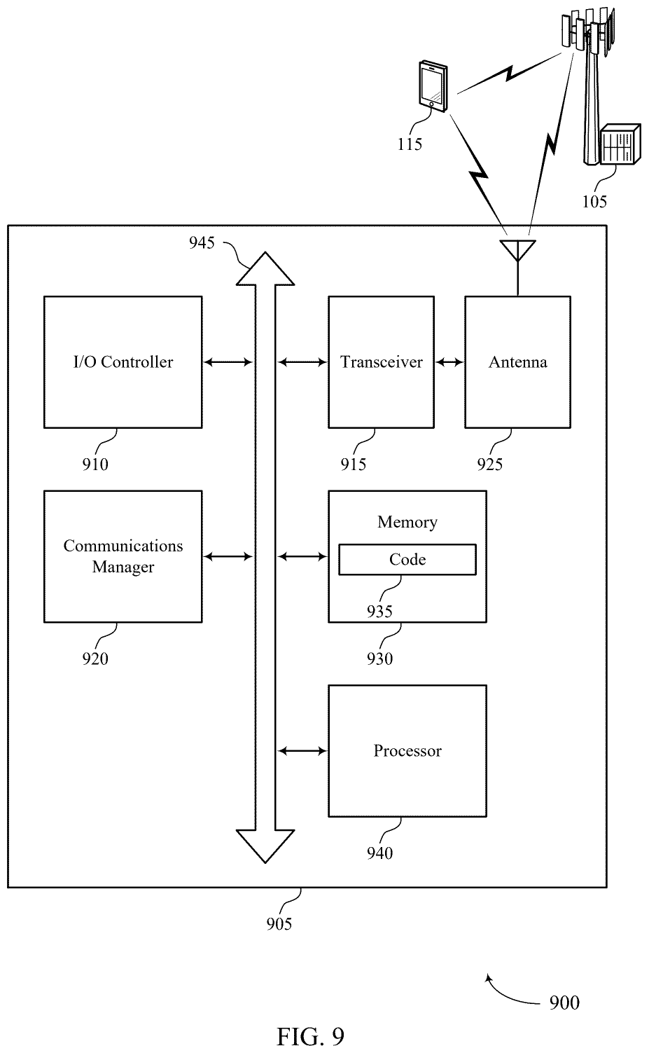

FIG. 8 shows a block diagram 800 of a communications manager 820 that supports soft-biased SCL polar decoding in accordance with one or more aspects of the present disclosure. The communications manager 820 may be an example of aspects of a communications manager 620, a communications manager 720, or both, as described herein. The communications manager 820, or various components thereof, may be an example of means for performing various aspects of soft-biased SCL polar decoding as described herein. For example, the communications manager 820 may include a control message component 825, a decoding component 830, a bias penalty component 835, a known bits component 840, an CRC component 845, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications in accordance with examples as disclosed herein. The control message component 825 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The decoding component 830 is capable of, configured to, or operable to support a means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

In some examples, the known bits component 840 is capable of, configured to, or operable to support a means for receiving a set of multiple control messages, where the known bits information is based on the set of multiple control messages.

In some examples, the bias penalty value is based on a quantity of known bits having a same bit value at a respective bit position across a set of multiple control messages.

In some examples, the bias penalty value biases the one or more bit decisions in the first list decoding bit sequence towards a first bit value based on a quantity of known bits having a same bit value at a respective bit position across a set of multiple control messages.

In some examples, the bias penalty value biases the one or more bit decisions in the first list decoding bit sequence towards a second bit value based on a quantity of known bits having a same bit value at a respective bit position across a set of multiple control messages.

In some examples, bits of a previously received control message are stored in an interleaved state as at least a portion of the known bits information based on the bits of the previously received control message passing a cyclic redundancy check.

In some examples, the bias penalty component 835 is capable of, configured to, or operable to support a means for receiving one or more control messages, where the bias penalty value is based on a ratio of a quantity of bits of the one or more control messages having a first bit value and a total quantity of bits of the one or more control messages.

In some examples, the bias penalty component 835 is capable of, configured to, or operable to support a means for receiving an indication of a table that indicates one or more bias penalty values to apply to one or more bit decisions, where the SCL polar decoding is performed in accordance with the table.

In some examples, the bias penalty component 835 is capable of, configured to, or operable to support a means for receiving a control message indicating the bias penalty value.

Additionally, or alternatively, the communications manager 820 may support wireless communications in accordance with examples as disclosed herein. In some examples, the control message component 825 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The bias penalty component 835 is capable of, configured to, or operable to support a means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. In some examples, the decoding component 830 is capable of, configured to, or operable to support a means for performing SCL polar decoding on the set of multiple biased codeword bits to obtain the message payload of the first polar encoded control message.

In some examples, a second value of the set of multiple bias values is applied to a second codeword bit of the set of multiple codeword bits based on known bit values for bit positions in the message payload in accordance with the known bits information.

In some examples, the CRC component 845 is capable of, configured to, or operable to support a means for applying a second bias value of the set of multiple bias values to one or more cyclic redundancy check bits of the first polar encoded control message to obtain one or more biased cyclic redundancy check bits, where SCL polar decoding is performed based on the one or more biased cyclic redundancy check bits.

In some examples, a second bias value of the set of multiple bias values associated with a frozen bit of the first polar encoded control message differs from a third bias value of the set of multiple bias values associated with a data bit of the first polar encoded control message.

In some examples, the third bias value is based on bias values of the set of multiple bias values associated with a set of multiple data bits of the message payload after cyclic redundancy check interleaving and bit mapping.

In some examples, the message payload has a fixed payload size.

FIG. 9 shows a diagram of a system 900 including a device 905 that supports soft-biased SCL polar decoding in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting soft-biased SCL polar decoding). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 920 is capable of, configured to, or operable to support a means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Additionally, or alternatively, the communications manager 920 may support wireless communications in accordance with examples as disclosed herein. For example, the communications manager 920 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 920 is capable of, configured to, or operable to support a means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. The communications manager 920 is capable of, configured to, or operable to support a means for performing SCL polar decoding on the set of multiple biased codeword bits to obtain the message payload of the first polar encoded control message.

By including or configuring the communications manager 920 in accordance with examples as described herein, the device 905 may support techniques for improved communication reliability, reduced latency, improved user experience related to reduced processing, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of soft-biased SCL polar decoding as described herein, or the at least one processor 940 and the at least one memory 930 may be otherwise configured to, individually or collectively, perform or support such operations.

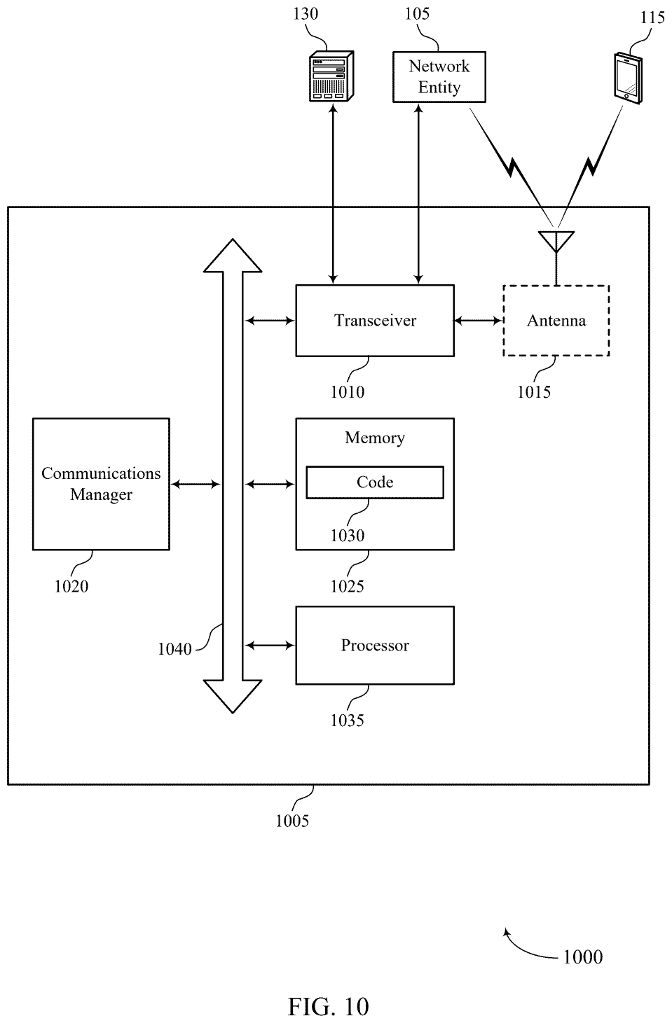

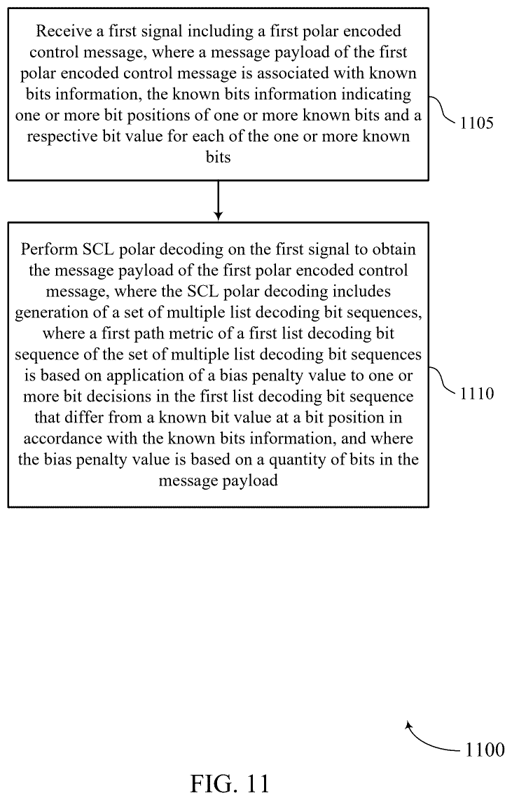

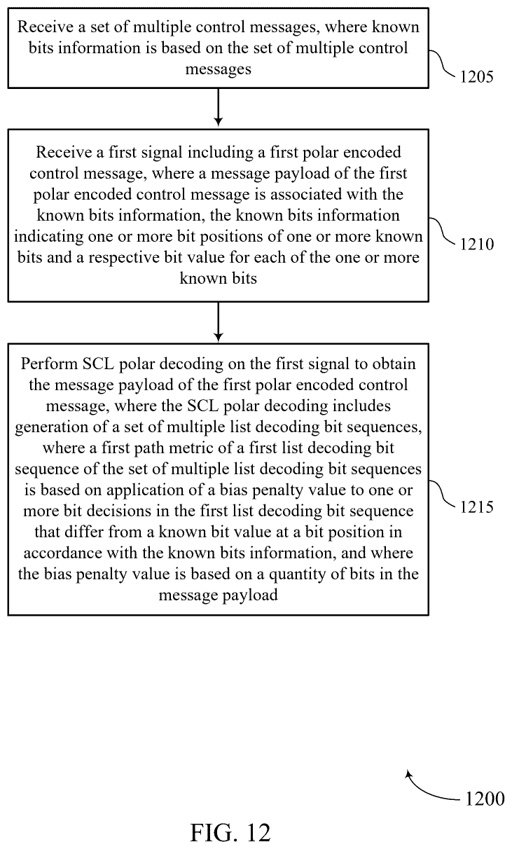

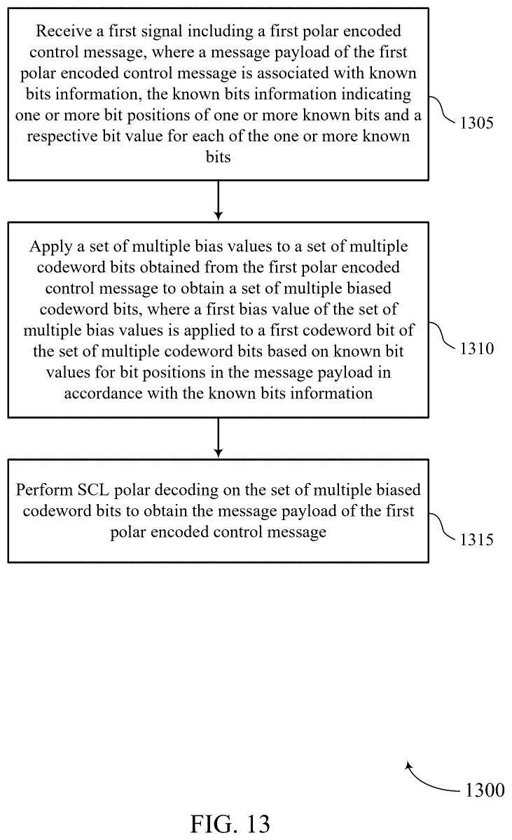

FIG. 10 shows a diagram of a system 1000 including a device 1005 that supports soft-biased SCL polar decoding in accordance with one or more aspects of the present disclosure. The device 1005 may be an example of or include components of a device 605, a device 705, or a network entity 105 as described herein. The device 1005 may communicate with other network devices or network equipment such as one or more of the network entities 105, UEs 115, or any combination thereof. The communications may include communications over one or more wired interfaces, over one or more wireless interfaces, or any combination thereof. The device 1005 may include components that support outputting and obtaining communications, such as a communications manager 1020, a transceiver 1010, one or more antennas 1015, at least one memory 1025, code 1030, and at least one processor 1035. These components may be in electronic communication or otherwise coupled (e.g., operatively, communicatively, functionally, electronically, electrically) via one or more buses (e.g., a bus 1040).

The transceiver 1010 may support bi-directional communications via wired links, wireless links, or both as described herein. In some examples, the transceiver 1010 may include a wired transceiver and may communicate bi-directionally with another wired transceiver. Additionally, or alternatively, in some examples, the transceiver 1010 may include a wireless transceiver and may communicate bi-directionally with another wireless transceiver. In some examples, the device 1005 may include one or more antennas 1015, which may be capable of transmitting or receiving wireless transmissions (e.g., concurrently). The transceiver 1010 may also include a modem to modulate signals, to provide the modulated signals for transmission (e.g., by one or more antennas 1015, by a wired transmitter), to receive modulated signals (e.g., from one or more antennas 1015, from a wired receiver), and to demodulate signals. In some implementations, the transceiver 1010 may include one or more interfaces, such as one or more interfaces coupled with the one or more antennas 1015 that are configured to support various receiving or obtaining operations, or one or more interfaces coupled with the one or more antennas 1015 that are configured to support various transmitting or outputting operations, or a combination thereof. In some implementations, the transceiver 1010 may include or be configured for coupling with one or more processors or one or more memory components that are operable to perform or support operations based on received or obtained information or signals, or to generate information or other signals for transmission or other outputting, or any combination thereof. In some implementations, the transceiver 1010, or the transceiver 1010 and the one or more antennas 1015, or the transceiver 1010 and the one or more antennas 1015 and one or more processors or one or more memory components (e.g., the at least one processor 1035, the at least one memory 1025, or both), may be included in a chip or chip assembly that is installed in the device 1005. In some examples, the transceiver 1010 may be operable to support communications via one or more communications links (e.g., communication link(s) 125, backhaul communication link(s) 120, a midhaul communication link 162, a fronthaul communication link 168).

The at least one memory 1025 may include RAM, ROM, or any combination thereof. The at least one memory 1025 may store computer-readable, computer-executable, or processor-executable code, such as the code 1030. The code 1030 may include instructions that, when executed by one or more of the at least one processor 1035, cause the device 1005 to perform various functions described herein. The code 1030 may be stored in a non-transitory computer-readable medium such as system memory or another type of memory. In some cases, the code 1030 may not be directly executable by a processor of the at least one processor 1035 but may cause a computer (e.g., when compiled and executed) to perform functions described herein. In some cases, the at least one memory 1025 may include, among other things, a BIOS which may control basic hardware or software operation such as the interaction with peripheral components or devices. In some examples, the at least one processor 1035 may include multiple processors and the at least one memory 1025 may include multiple memories. One or more of the multiple processors may be coupled with one or more of the multiple memories which may, individually or collectively, be configured to perform various functions herein (for example, as part of a processing system).

The at least one processor 1035 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1035 may be configured to operate a memory array using a memory controller. In some other cases, a memory controller may be integrated into one or more of the at least one processor 1035. The at least one processor 1035 may be configured to execute computer-readable instructions stored in a memory (e.g., one or more of the at least one memory 1025) to cause the device 1005 to perform various functions (e.g., functions or tasks supporting soft-biased SCL polar decoding). For example, the device 1005 or a component of the device 1005 may include at least one processor 1035 and at least one memory 1025 coupled with one or more of the at least one processor 1035, the at least one processor 1035 and the at least one memory 1025 configured to perform various functions described herein. The at least one processor 1035 may be an example of a cloud-computing platform (e.g., one or more physical nodes and supporting software such as operating systems, virtual machines, or container instances) that may host the functions (e.g., by executing code 1030) to perform the functions of the device 1005. The at least one processor 1035 may be any one or more suitable processors capable of executing scripts or instructions of one or more software programs stored in the device 1005 (such as within one or more of the at least one memory 1025).

In some examples, the at least one processor 1035 may include multiple processors and the at least one memory 1025 may include multiple memories. One or more of the multiple processors may be coupled with one or more of the multiple memories, which may, individually or collectively, be configured to perform various functions herein. In some examples, the at least one processor 1035 may be a component of a processing system, which may refer to a system (such as a series) of machines, circuitry (including, for example, one or both of processor circuitry (which may include the at least one processor 1035) and memory circuitry (which may include the at least one memory 1025)), or components, that receives or obtains inputs and processes the inputs to produce, generate, or obtain a set of outputs. The processing system may be configured to perform one or more of the functions described herein. For example, the at least one processor 1035 or a processing system including the at least one processor 1035 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code stored in the at least one memory 1025 or otherwise, to perform one or more of the functions described herein.

In some examples, a bus 1040 may support communications of (e.g., within) a protocol layer of a protocol stack. In some examples, a bus 1040 may support communications associated with a logical channel of a protocol stack (e.g., between protocol layers of a protocol stack), which may include communications performed within a component of the device 1005, or between different components of the device 1005 that may be co-located or located in different locations (e.g., where the device 1005 may refer to a system in which one or more of the communications manager 1020, the transceiver 1010, the at least one memory 1025, the code 1030, and the at least one processor 1035 may be located in one of the different components or divided between different components).

In some examples, the communications manager 1020 may manage aspects of communications with a core network 130 (e.g., via one or more wired or wireless backhaul links). For example, the communications manager 1020 may manage the transfer of data communications for client devices, such as one or more UEs 115. In some examples, the communications manager 1020 may manage communications with one or more other network entities 105, and may include a controller or scheduler for controlling communications with UEs 115 (e.g., in cooperation with the one or more other network devices). In some examples, the communications manager 1020 may support an X2 interface within an LTE/LTE-A wireless communications network technology to provide communication between network entities 105.

The communications manager 1020 may support wireless communications in accordance with examples as disclosed herein. For example, the communications manager 1020 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 1020 is capable of, configured to, or operable to support a means for performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload.

Additionally, or alternatively, the communications manager 1020 may support wireless communications in accordance with examples as disclosed herein. For example, the communications manager 1020 is capable of, configured to, or operable to support a means for receiving a first signal including a first polar encoded control message, where a message payload of the first polar encoded control message is associated with known bits information, the known bits information indicating one or more bit positions of one or more known bits and a respective bit value for each of the one or more known bits. The communications manager 1020 is capable of, configured to, or operable to support a means for applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. The communications manager 1020 is capable of, configured to, or operable to support a means for performing SCL polar decoding on the set of multiple biased codeword bits to obtain the message payload of the first polar encoded control message.

By including or configuring the communications manager 1020 in accordance with examples as described herein, the device 1005 may support techniques for improved communication reliability, reduced latency, improved user experience related to reduced processing, more efficient utilization of communication resources, and improved coordination between devices.

In some examples, the communications manager 1020 may be configured to perform various operations (e.g., receiving, obtaining, monitoring, outputting, transmitting) using or otherwise in cooperation with the transceiver 1010, the one or more antennas 1015 (e.g., where applicable), or any combination thereof. Although the communications manager 1020 is illustrated as a separate component, in some examples, one or more functions described with reference to the communications manager 1020 may be supported by or performed by the transceiver 1010, one or more of the at least one processor 1035, one or more of the at least one memory 1025, the code 1030, or any combination thereof (for example, by a processing system including at least a portion of the at least one processor 1035, the at least one memory 1025, the code 1030, or any combination thereof). For example, the code 1030 may include instructions executable by one or more of the at least one processor 1035 to cause the device 1005 to perform various aspects of soft-biased SCL polar decoding as described herein, or the at least one processor 1035 and the at least one memory 1025 may be otherwise configured to, individually or collectively, perform or support such operations.

FIG. 11 shows a flowchart illustrating a method 1100 that supports soft-biased SCL polar decoding in accordance with one or more aspects of the present disclosure. The operations of the method 1100 may be implemented by a UE or a network entity or its components as described herein. For example, the operations of the method 1100 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1105, the method may include receiving a first signal including a first polar encoded control message, where a message payload of the first polar encoded control message is associated with known bits information, the known bits information indicating one or more bit positions of one or more known bits and a respective bit value for each of the one or more known bits. The operations of 1105 may be performed in accordance with examples as disclosed herein. In some examples, aspects of the operations of 1105 may be performed by a control message component 825 as described with reference to FIG. 8.

At 1110, the method may include performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload. The operations of 1110 may be performed in accordance with examples as disclosed herein. In some examples, aspects of the operations of 1110 may be performed by a decoding component 830 as described with reference to FIG. 8.

FIG. 12 shows a flowchart illustrating a method 1200 that supports soft-biased SCL polar decoding in accordance with one or more aspects of the present disclosure. The operations of the method 1200 may be implemented by a UE or a network entity or its components as described herein. For example, the operations of the method 1200 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1205, the method may include receiving a set of multiple control messages, where the known bits information is based on the set of multiple control messages. The operations of 1205 may be performed in accordance with examples as disclosed herein. In some examples, aspects of the operations of 1205 may be performed by a known bits component 840 as described with reference to FIG. 8.

At 1210, the method may include receiving a first signal including a first polar encoded control message, where a message payload of the first polar encoded control message is associated with known bits information, the known bits information indicating one or more bit positions of one or more known bits and a respective bit value for each of the one or more known bits. The operations of 1210 may be performed in accordance with examples as disclosed herein. In some examples, aspects of the operations of 1210 may be performed by a control message component 825 as described with reference to FIG. 8.

At 1215, the method may include performing SCL polar decoding on the first signal to obtain the message payload of the first polar encoded control message, where the SCL polar decoding includes generation of a set of multiple list decoding bit sequences, where a first path metric of a first list decoding bit sequence of the set of multiple list decoding bit sequences is based on application of a bias penalty value to one or more bit decisions in the first list decoding bit sequence that differ from a known bit value at a bit position in accordance with the known bits information, and where the bias penalty value is based on a quantity of bits in the message payload. The operations of 1215 may be performed in accordance with examples as disclosed herein. In some examples, aspects of the operations of 1215 may be performed by a decoding component 830 as described with reference to FIG. 8.

FIG. 13 shows a flowchart illustrating a method 1300 that supports soft-biased SCL polar decoding in accordance with one or more aspects of the present disclosure. The operations of the method 1300 may be implemented by a UE or a network entity or its components as described herein. For example, the operations of the method 1300 may be performed by a UE 115 or a network entity as described with reference to FIGS. 1 through 10. In some examples, a UE or a network entity may execute a set of instructions to control the functional elements of the UE or the network entity to perform the described functions. Additionally, or alternatively, the UE or the network entity may perform aspects of the described functions using special-purpose hardware.

At 1305, the method may include receiving a first signal including a first polar encoded control message, where a message payload of the first polar encoded control message is associated with known bits information, the known bits information indicating one or more bit positions of one or more known bits and a respective bit value for each of the one or more known bits. The operations of 1305 may be performed in accordance with examples as disclosed herein. In some examples, aspects of the operations of 1305 may be performed by a control message component 825 as described with reference to FIG. 8.

At 1310, the method may include applying a set of multiple bias values to a set of multiple codeword bits obtained from the first polar encoded control message to obtain a set of multiple biased codeword bits, where a first bias value of the set of multiple bias values is applied to a first codeword bit of the set of multiple codeword bits based on known bit values for bit positions in the message payload in accordance with the known bits information. The operations of 1310 may be performed in accordance with examples as disclosed herein. In some examples, aspects of the operations of 1310 may be performed by a bias penalty component 835 as described with reference to FIG. 8.

At 1315, the method may include performing SCL polar decoding on the set of multiple biased codeword bits to obtain the message payload of the first polar encoded control message. The operations of 1315 may be performed in accordance with examples as disclosed herein. In some examples, aspects of the operations of 1315 may be performed by a decoding component 830 as described with reference to FIG. 8.

The following provides an overview of aspects of the present disclosure:

Aspect 1: A method for wireless communications at a wireless device, comprising: receiving a first signal comprising a first polar encoded control message, wherein a message payload of the first polar encoded control message is associated with known bits information, the known bits information indicating one or more bit positions of one or more known bits and a respective bit value for each of the one or more known bits; and performing successive cancellation list polar decoding on the first signal to obtain the message payload of the first polar encoded control message, wherein the successive cancellation list polar decoding comprises generation of a plurality of list decoding bit sequences, wherein a first path metric of a first list decoding bit sequence of the plurality of list decoding bit sequences is based at least in part on application of a bias penalty value to one or more bit decisions in the first list decoding bit sequence that differ from a known bit value at a bit position in accordance with the known bits information, and wherein the bias penalty value is based at least in part on a quantity of bits in the message payload.

Aspect 2: The method of aspect 1, further comprising: receiving a plurality of control messages, wherein the known bits information is based on the plurality of control messages.

Aspect 3: The method of any of aspects 1 through 2, wherein the bias penalty value is based at least in part on a quantity of known bits having a same bit value at a respective bit position across a plurality of control messages.

Aspect 4: The method of any of aspects 1 through 3, wherein the bias penalty value biases the one or more bit decisions in the first list decoding bit sequence towards a first bit value based at least in part on a quantity of known bits having a same bit value at a respective bit position across a plurality of control messages.

Aspect 5: The method of any of aspects 1 through 3, wherein the bias penalty value biases the one or more bit decisions in the first list decoding bit sequence towards a second bit value based at least in part on a quantity of known bits having a same bit value at a respective bit position across a plurality of control messages.

Aspect 6: The method of any of aspects 1 through 5, wherein bits of a previously received control message are stored in an interleaved state as at least a portion of the known bits information based at least in part on the bits of the previously received control message passing a cyclic redundancy check.

Aspect 7: The method of any of aspects 1 through 6, further comprising: receiving one or more control messages, wherein the bias penalty value is based at least in part on a ratio of a quantity of bits of the one or more control messages having a first bit value and a total quantity of bits of the one or more control messages.

Aspect 8: The method of any of aspects 1 through 7, further comprising: receiving an indication of a table that indicates one or more bias penalty values to apply to one or more bit decisions, wherein the successive cancellation list polar decoding is performed in accordance with the table.

Aspect 9: The method of any of aspects 1 through 8, further comprising: receiving a control message indicating the bias penalty value.

Aspect 10: A method for wireless communications at a wireless device, comprising: receiving a first signal comprising a first polar encoded control message, wherein a message payload of the first polar encoded control message is associated with known bits information, the known bits information indicating one or more bit positions of one or more known bits and a respective bit value for each of the one or more known bits; applying a plurality of bias values to a plurality of codeword bits obtained from the first polar encoded control message to obtain a plurality of biased codeword bits, wherein a first bias value of the plurality of bias values is applied to a first codeword bit of the plurality of codeword bits based at least in part on known bit values for bit positions in the message payload in accordance with the known bits information; and performing successive cancellation list polar decoding on the plurality of biased codeword bits to obtain the message payload of the first polar encoded control message.

Aspect 11: The method of aspect 10, wherein a second value of the plurality of bias values is applied to a second codeword bit of the plurality of codeword bits based at least in part on known bit values for bit positions in the message payload in accordance with the known bits information.

Aspect 12: The method of any of aspects 10 through 11, further comprising: applying a second bias value of the plurality of bias values to one or more cyclic redundancy check bits of the first polar encoded control message to obtain one or more biased cyclic redundancy check bits, wherein successive cancellation list polar decoding is performed based at least in part on the one or more biased cyclic redundancy check bits.

Aspect 13: The method of any of aspects 10 through 12, wherein a second bias value of the plurality of bias values associated with a frozen bit of the first polar encoded control message differs from a third bias value of the plurality of bias values associated with a data bit of the first polar encoded control message.

Aspect 14: The method of aspect 13, wherein the third bias value is based at least in part on bias values of the plurality of bias values associated with a plurality of data bits of the message payload after cyclic redundancy check interleaving and bit mapping.

Aspect 15: The method of any of aspects 13 through 14, wherein the message payload has a fixed payload size.

Aspect 16: A wireless device for wireless communications, comprising one or more memories storing processor-executable code, and one or more processors coupled with the one or more memories and individually or collectively operable to execute the code to cause the wireless device to perform a method of any of aspects 1 through 9.

Aspect 17: A wireless device for wireless communications, comprising at least one means for performing a method of any of aspects 1 through 9.

Aspect 18: A non-transitory computer-readable medium storing code for wireless communications, the code comprising instructions executable by one or more processors to perform a method of any of aspects 1 through 9.

Aspect 19: A wireless device for wireless communications, comprising one or more memories storing processor-executable code, and one or more processors coupled with the one or more memories and individually or collectively operable to execute the code to cause the wireless device to perform a method of any of aspects 10 through 15.

Aspect 20: A wireless device for wireless communications, comprising at least one means for performing a method of any of aspects 10 through 15.

Aspect 21: A non-transitory computer-readable medium storing code for wireless communications, the code comprising instructions executable by one or more processors to perform a method of any of aspects 10 through 15.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
receive a first signal comprising a first polar encoded control message, wherein a message payload of the first polar encoded control message is associated with known bits information, the known bits information indicating one or more bit positions of one or more known bits and a respective bit value for each of the one or more known bits; and
perform successive cancellation list polar decoding on the first signal to obtain the message payload of the first polar encoded control message, wherein the successive cancellation list polar decoding comprises generation of a plurality of list decoding bit sequences, wherein a first path metric of a first list decoding bit sequence of the plurality of list decoding bit sequences is based at least in part on application of a bias penalty value to one or more bit decisions in the first list decoding bit sequence that differ from a known bit value at a bit position in accordance with the known bits information, and wherein the bias penalty value is based at least in part on a quantity of bits in the message payload.

2. The wireless device of claim 1, wherein the one or more processors are individually or collectively further operable to execute the code to cause the wireless device to:
receive a plurality of control messages, wherein the known bits information is based on the plurality of control messages.

3. The wireless device of claim 1, wherein the bias penalty value is based at least in part on a quantity of known bits having a same bit value at a respective bit position across a plurality of control messages.

4. The wireless device of claim 1, wherein the bias penalty value biases the one or more bit decisions in the first list decoding bit sequence towards a first bit value based at least in part on a quantity of known bits having a same bit value at a respective bit position across a plurality of control messages.

5. The wireless device of claim 1, wherein the bias penalty value biases the one or more bit decisions in the first list decoding bit sequence towards a second bit value based at least in part on a quantity of known bits having a same bit value at a respective bit position across a plurality of control messages.

6. The wireless device of claim 1, wherein bits of a previously received control message are stored in an interleaved state as at least a portion of the known bits information based at least in part on the bits of the previously received control message passing a cyclic redundancy check.

7. The wireless device of claim 1, wherein the one or more processors are individually or collectively further operable to execute the code to cause the wireless device to:
receive one or more control messages, wherein the bias penalty value is based at least in part on a ratio of a quantity of bits of the one or more control messages having a first bit value and a total quantity of bits of the one or more control messages.

8. The wireless device of claim 1, wherein the one or more processors are individually or collectively further operable to execute the code to cause the wireless device to:
receive an indication of a table that indicates one or more bias penalty values to apply to one or more bit decisions, wherein the successive cancellation list polar decoding is performed in accordance with the table.

9. The wireless device of claim 1, wherein the one or more processors are individually or collectively further operable to execute the code to cause the wireless device to:
receive a control message indicating the bias penalty value.

10. A wireless device, comprising:
one or more memories storing processor-executable code; and
one or more processors coupled with the one or more memories and individually or collectively operable to execute the code to cause the wireless device to:
receive a first signal comprising a first polar encoded control message, wherein a message payload of the first polar encoded control message is associated with known bits information, the known bits information indicating one or more bit positions of one or more known bits and a respective bit value for each of the one or more known bits;
apply a plurality of bias values to a plurality of codeword bits obtained from the first polar encoded control message to obtain a plurality of biased codeword bits, wherein a first bias value of the plurality of bias values is applied to a first codeword bit of the plurality of codeword bits based at least in part on known bit values for bit positions in the message payload in accordance with the known bits information; and
perform successive cancellation list polar decoding on the plurality of biased codeword bits to obtain the message payload of the first polar encoded control message.

11. The wireless device of claim 10, wherein a second value of the plurality of bias values is applied to a second codeword bit of the plurality of codeword bits based at least in part on known bit values for bit positions in the message payload in accordance with the known bits information.

12. The wireless device of claim 10, wherein the one or more processors are individually or collectively further operable to execute the code to cause the wireless device to:
apply a second bias value of the plurality of bias values to one or more cyclic redundancy check bits of the first polar encoded control message to obtain one or more biased cyclic redundancy check bits, wherein successive cancellation list polar decoding is performed based at least in part on the one or more biased cyclic redundancy check bits.

13. The wireless device of claim 10, wherein a second bias value of the plurality of bias values associated with a frozen bit of the first polar encoded control message differs from a third bias value of the plurality of bias values associated with a data bit of the first polar encoded control message.

14. The wireless device of claim 13, wherein the third bias value is based at least in part on bias values of the plurality of bias values associated with a plurality of data bits of the message payload after cyclic redundancy check interleaving and bit mapping.

15. The wireless device of claim 13, wherein the message payload has a fixed payload size.

16. A method for wireless communications at a wireless device, comprising:
receiving a first signal comprising a first polar encoded control message, wherein a message payload of the first polar encoded control message is associated with known bits information, the known bits information indicating one or more bit positions of one or more known bits and a respective bit value for each of the one or more known bits; and
performing successive cancellation list polar decoding on the first signal to obtain the message payload of the first polar encoded control message, wherein the successive cancellation list polar decoding comprises generation of a plurality of list decoding bit sequences, wherein a first path metric of a first list decoding bit sequence of the plurality of list decoding bit sequences is based at least in part on application of a bias penalty value to one or more bit decisions in the first list decoding bit sequence that differ from a known bit value at a bit position in accordance with the known bits information, and wherein the bias penalty value is based at least in part on a quantity of bits in the message payload.

17. The method of claim 16, further comprising:
receiving a plurality of control messages, wherein the known bits information is based on the plurality of control messages.

18. The method of claim 16, wherein the bias penalty value is based at least in part on a quantity of known bits having a same bit value at a respective bit position across a plurality of control messages.

19. The method of claim 16, wherein the bias penalty value biases the one or more bit decisions in the first list decoding bit sequence towards a first bit value based at least in part on a quantity of known bits having a same bit value at a respective bit position across a plurality of control messages.

20. The method of claim 16, wherein the bias penalty value biases the one or more bit decisions in the first list decoding bit sequence towards a second bit value based at least in part on a quantity of known bits having a same bit value at a respective bit position across a plurality of control messages.

21. The method of claim 16, wherein bits of a previously received control message are stored in an interleaved state as at least a portion of the known bits information based at least in part on the bits of the previously received control message passing a cyclic redundancy check.

22. The method of claim 16, further comprising:
receiving one or more control messages, wherein the bias penalty value is based at least in part on a ratio of a quantity of bits of the one or more control messages having a first bit value and a total quantity of bits of the one or more control messages.

23. The method of claim 16, further comprising:
receiving an indication of a table that indicates one or more bias penalty values to apply to one or more bit decisions, wherein the successive cancellation list polar decoding is performed in accordance with the table.

24. The method of claim 16, further comprising:
receiving a control message indicating the bias penalty value.

25. A method for wireless communications at a wireless device, comprising:
receiving a first signal comprising a first polar encoded control message, wherein a message payload of the first polar encoded control message is associated with known bits information, the known bits information indicating one or more bit positions of one or more known bits and a respective bit value for each of the one or more known bits;
applying a plurality of bias values to a plurality of codeword bits obtained from the first polar encoded control message to obtain a plurality of biased codeword bits, wherein a first bias value of the plurality of bias values is applied to a first codeword bit of the plurality of codeword bits based at least in part on known bit values for bit positions in the message payload in accordance with the known bits information; and
performing successive cancellation list polar decoding on the plurality of biased codeword bits to obtain the message payload of the first polar encoded control message.

26. The method of claim 25, wherein a second value of the plurality of bias values is applied to a second codeword bit of the plurality of codeword bits based at least in part on known bit values for bit positions in the message payload in accordance with the known bits information.

27. The method of claim 25, further comprising:
applying a second bias value of the plurality of bias values to one or more cyclic redundancy check bits of the first polar encoded control message to obtain one or more biased cyclic redundancy check bits, wherein successive cancellation list polar decoding is performed based at least in part on the one or more biased cyclic redundancy check bits.

28. The method of claim 25, wherein a second bias value of the plurality of bias values associated with a frozen bit of the first polar encoded control message differs from a third bias value of the plurality of bias values associated with a data bit of the first polar encoded control message.

29. The method of claim 28, wherein the third bias value is based at least in part on bias values of the plurality of bias values associated with a plurality of data bits of the message payload after cyclic redundancy check interleaving and bit mapping.

30. The method of claim 28, wherein the message payload has a fixed payload size.
